(19) United States
(12) Patent Application Publication
(10) Pub. No.: US 2014/0175048 A1
(43) Pub. Date: Jun. 26, 2014

(54) ELECTRICAL LAPPING GUIDE FOR MANUFACTURE OF A SCISSOR STYLE MAGNETIC SENSOR

(71) Applicant: HGST NETHERLANDS B.V., Amsterdam (NL)

(72) Inventors: David P. Druist, Santa Clara, CA (US); Quang Le, San Jose, CA (US); Yang Li, San Jose, CA (US); David J. Seagle, Morgan Hill, CA (US); Petrus A. Van Der Heijden, Cupertino, CA (US)

(73) Assignee: HGST NETHERLANDS B.V., Amsterdam (NL)

(21) Appl. No.: 13/725,479

(22) Filed: Dec. 21, 2012

(51) Int. Cl. G11B 5/31

(52) U.S. Cl. CPC G11B 5/3169
USPC 216/19

(57) ABSTRACT

A method of manufacturing a magnetic sensor having a hard bias structure located at a back edge of the sensor. The method forms an electrical lapping guide that is compatible for use with such a sensor having a back edge hard bias structure and which can accurately determine a termination point for a lapping operation that forms an air bearing surface of the slider and determines the sensor stripe height.

The present invention relates to magnetic data recording and more particularly to a method of manufacturing a novel electric lapping guide for use in manufacturing a scissor style magnetic read sensor having a back edge hard bias structure, and non-magnetic, electrically insulating side fill layers.

### BACKGROUND OF THE INVENTION

The heart of a computer is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected circular tracks on the rotating disk. The read and write heads are directly located on a slider that has an air bearing surface (ABS). The suspension arm biases the slider into contact with the surface of the disk when the disk is not rotating, but when the disk rotates air is swirled by the rotating disk. When the slider rides on the air bearing, the write and read heads are employed for writing magnetic impressions to and reading magnetic impressions from the rotating disk. The read and write heads are connected to processing circuitry that operates according to a computer program to implement the writing and reading functions.

The write head includes at least one coil, a write pole and one or more return poles. When a current flows through the coil, a resulting magnetic field causes a magnetic flux to flow through the write pole, which results in a magnetic write field emitting from the tip of the write pole. This magnetic field is sufficiently strong that it locally magnetizes a portion of the adjacent magnetic disk, thereby recording a bit of data. The write field, then, travels through a magnetically soft under-layer of the magnetic medium to return to the return pole of the write head.

A magnetoresistive sensor such as a Giant Magnetoresistive (GMR) sensor or a Tunnel Junction Magnetoresistive (TMR) sensor can be employed to read a magnetic signal from the magnetic media. The magnetoresistive sensor has an electrical resistance that changes in response to an external magnetic field. This change in electrical resistance can be detected by processing circuitry in order to read magnetic data from the adjacent magnetic media.

As the need for data density increases there is an ever present need to decrease the size of a magnetic read sensor. With regard to linear data density along a data track, this means reducing the gap thickness of a magnetic sensor. Currently used sensor such as GMR and TMR sensors discussed above require a pinning structure that consumes a large amount of gap thickness. One way to overcome this is to construct a sensor as scissor sensor that has two anti-parallel coupled free layers, but no pinned layer. The elimination of the pinning structure has the potential to greatly decrease the gap thickness. However, the use of such a magnetic sensor results in design and manufacturing challenges.

### SUMMARY OF THE INVENTION

The present invention provides a method of manufacturing a magnetic sensor that includes depositing a sensor material and ion milling out sensor in an electrical lapping guide region and depositing an electrically conductive material. A mask is then formed having a first opening with an edge configured to define back edge of a sensor and having second and third openings the distance between which is defines an electrical lapping guide. An ion milling is performed to remove material not protected by the mask structure. Then, an electrical insulation layer and a magnetic hard bias layer are deposited.

The sensor can also be constructed by a process that includes, forming a sensor layer having a track-width, and then forming a mask having a first opening with an edge that is configured to define a sensor back edge and having a second opening defining an electrical lapping guide. An ion milling is performed to remove material exposed through the first and second openings. Then, a layer of electrically insulating material and a layer of hard magnetic bias material are deposited, and a chemical mechanical polishing process is performed.

The method of manufacturing a magnetic sensor defines the electrical lapping guide in the same photolithographic and ion milling steps used to define the back edge or stripe height of the sensor, and which also defines where hard bias material will be deposited. The method advantageously provides accurate alignment of the ELG back edge with the back edge of the sensor for accurate stripe height control during lapping.

These and other features and advantages of the invention will be apparent upon reading of the following detailed description of preferred embodiments taken in conjunction with the figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an ABS view of a slider illustrating the location of a magnetic head thereon;

FIG. 3 is an air bearing surface view of a prior art magnetic read sensor;

FIG. 4 is a top down, exploded, schematic view of a portion of the read element of FIG. 3;

FIGS. 5-19 show a magnetic sensor and lapping guide in various intermediate stages of manufacture in order to illustrate a method of manufacturing a magnetic sensor according to an embodiment of the invention; and

FIGS. 20-27 show a magnetic sensor and lapping guide in various intermediate stages of manufacture in order to illustrate a method of manufacturing a magnetic sensor according to an alternate embodiment of the invention

### DETAILED DESCRIPTION OF THE PREFERRED EMBODIMENTS

The following description is of the best embodiments presently contemplated for carrying out this invention. This description is made for the purpose of illustrating the general principles of this invention and is not meant to limit the inventive concepts claimed herein.

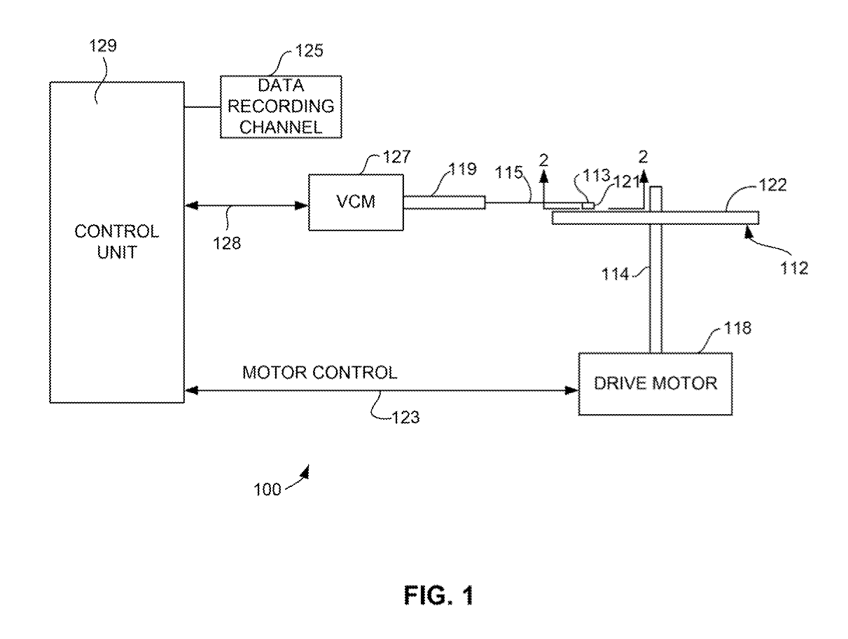

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves radially in and out over the disk surface 122 so that the magnetic head assembly 121 can access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control Signals on line 128. The control signals on line 128 provide the desired current profiles to optimally move and position slider 113 to the desired data track on disk 112. Write and read signals are communicated to and from write and read heads 121 by way of recording channel 125.

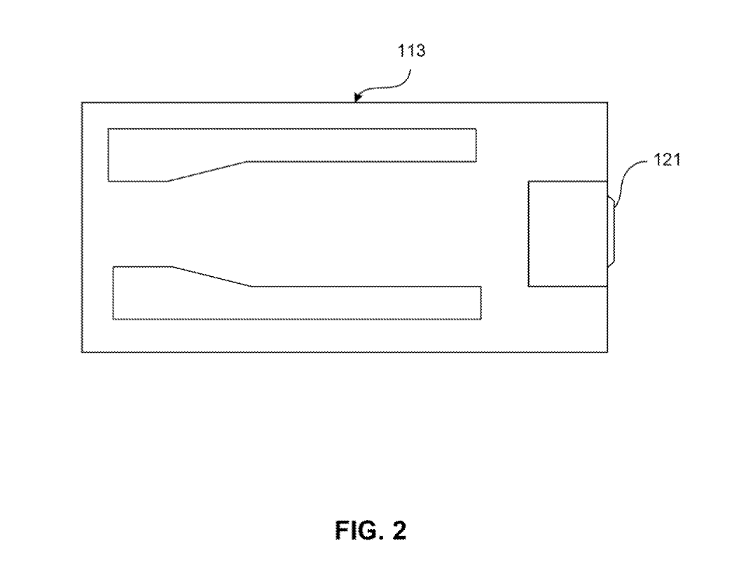

With reference to FIG. 2, the orientation of the magnetic head 121 in a slider 113 can be seen in more detail. FIG. 2 is an ABS view of the slider 113, and as can he seen the magnetic head including an inductive write head and a read sensor, is located at a trailing edge of the slider. The above description of a typical magnetic disk storage system and the accompanying illustration of FIG. 1 are for representation purposes only. It should be apparent that disk storage systems may contain a large number of disks and actuators, and each actuator may support a number of sliders.

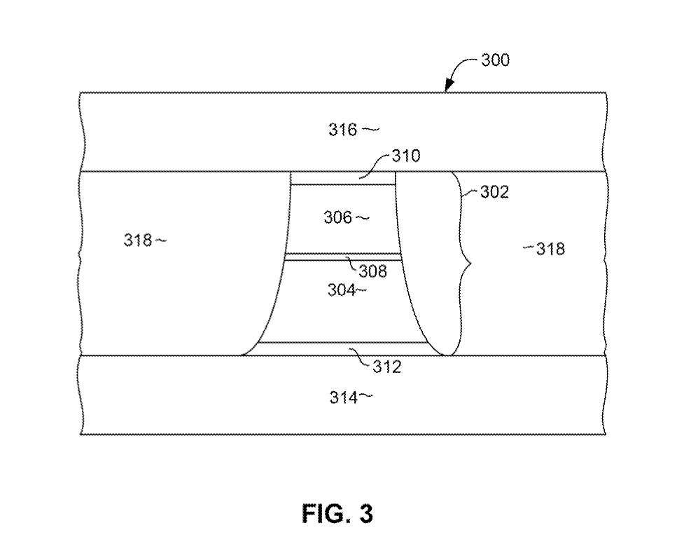

FIG. 3 shows a view of a magnetic read head 300 as viewed from the air bearing surface. The read head 300 is a scissor type magnetoresistive sensor having a sensor stack 302 that includes first and second free layers 304, 306 that are anti-parallel coupled across a non-magnetic layer 308 that can be a non-magnetic, electrically insulating barrier layer such as MgOx or an electrically insulating spacer layer such as AgSn. A capping layer structure 310 can be provided at the top of the sensor stack 302 to protect the layers of the sensor stack. The sensor stack 302 can also include a seed layer structure 312 at its bottom to promote a desired grain growth in the above formed layers.

The first and second magnetic layers 304, 306 can be constructed of multiple layers of magnetic material. For example, the first magnetic layer 304 can be constructed of: a layer of Ni—Fe; a layer of Co—Hf deposited over the layer of Ni—Fe; a layer of Co—Fe—B deposited over the layer of Co—Hf; and a layer of Co—Fe deposited over the layer of Co—Fe—B. The second magnetic layer 306 can be constructed of: a layer of Co—Fe; a layer of Co—Fe—B deposited over the layer of Co—Fe; a layer of Co—Hf deposited over the layer of Co—Fe—B; and a layer of Ni—Fe deposited over the layer of Co—Hf. The capping layer structure 310 can also be constructed as a multi-layer structure and can include first and second layers of Ru with a layer of Ta sandwiched there-between. The seed layer structure 312 can include a layer of Ta and a layer of Ru formed over the layer of Ta.

The sensor stack 302 is sandwiched between leading and trailing magnetic shields 314, 316, each of which can be constructed of a magnetic material such as Ni—Fe, of a composition having a high magnetic permeability (μ) to provide effective magnetic shielding.

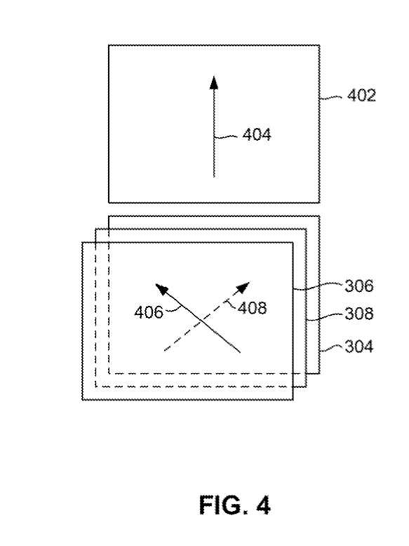

FIG. 4 shows an exploded, top-down view of the magnetic layers 304, 306 with the non-magnetic layer 308 there-between. The presence of the non-magnetic layer 308 between the first and second magnetic layers 304, 306 causes the magnetic layers 304, 306 to be magnetically anti-parallel coupled with one another. In addition, a hard magnetic bias structure 402 is provided at the back edge of the sensor layers (not shown in FIG. 3). The hard bias layer 402 has a magnetization perpendicular to the air bearing surface ABS, which is represented by arrow 404. The magnetic layers 304, 306 have a magnetic anisotropy that is parallel with the ABS, so that in the absence of a magnetic field 404 from the hard bias layer 402, the magnetizations of the layers 304, 306 would be oriented anti-parallel to one another in directions that are parallel with the ABS. However, the presence of the a bias field from the magnetization 404 of the bias layer 402 cants the magnetizations of the magnetic layers 304, 306 to a direction that is not parallel with the ABS. The direction of magnetizations of the magnetic layers 304, 306 are represented by arrows 406, 408, with the arrow 406 representing the direction of magnetization of the layer 304 and the arrow 408 representing the direction of magnetization of the layer 308. However, the magnetizations 406, 408, can move relative to one another in response to a magnetic field, such as from a magnetic media. This change in the directions of magnetizations 406, 408 relative to one another changes the electrical resistance across the barrier layer 308, and this change in resistance can be detected as a signal for reading magnetic data from a media such as the media 112 of FIG. 1.

Because sensor 300 has its hard bias structure 402 at the back edge, the sensor 300 does not require side hard bias structures. Therefore, with reference again to FIG. 3, the space at either side of the sensor stack 302 between the shields 314, 316 can be filled with a non-magnetic, electrically insulating material such as alumina, SiN, Ta₂O₅, or combination thereof. This electrically insulating fill layer provides good insulation assurance against any electrically shunting between the shields 314, 316, but also provides challenges with regard to manufacturing.

It will be appreciated that magnetic heads are formed on a wafer with thousands of such heads being formed on a single wafer. After the magnetic heads have been formed, a slicing operation is performed to slice the wafer into rows of sliders and a lapping operation is performed to move wafer material until a desired air bearing surface location has been reached. The point at which lapping terminates is determined by a lapping guide, the electrical resistance of which changes as wafer material is removed by lapping. When the electrical resistance reaches a predetermined level, lapping is terminated. Such lapping guides have been developed and patterned in a process that has also been used to define the hard bias structures, and have also used the side hard bias structure material as apart of the lapping guide. However, the elimination of hard bias structures at the sides of the sensor stack 302 makes previously developed lapping guide process unsuitable for manufacture in a scissor sensor having only a back edge hard bias structure. The present invention solves this problem by providing lapping designs and methods of manufacture that are compatible with the manufacture of a scissor sensor having only a back edge hard bias and no side hard bias structures.

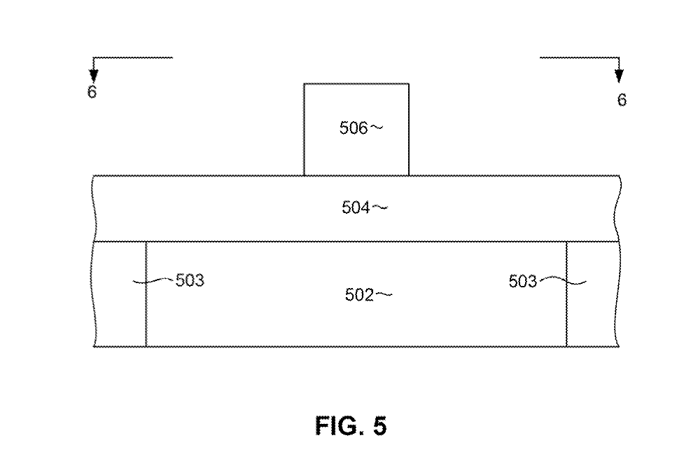

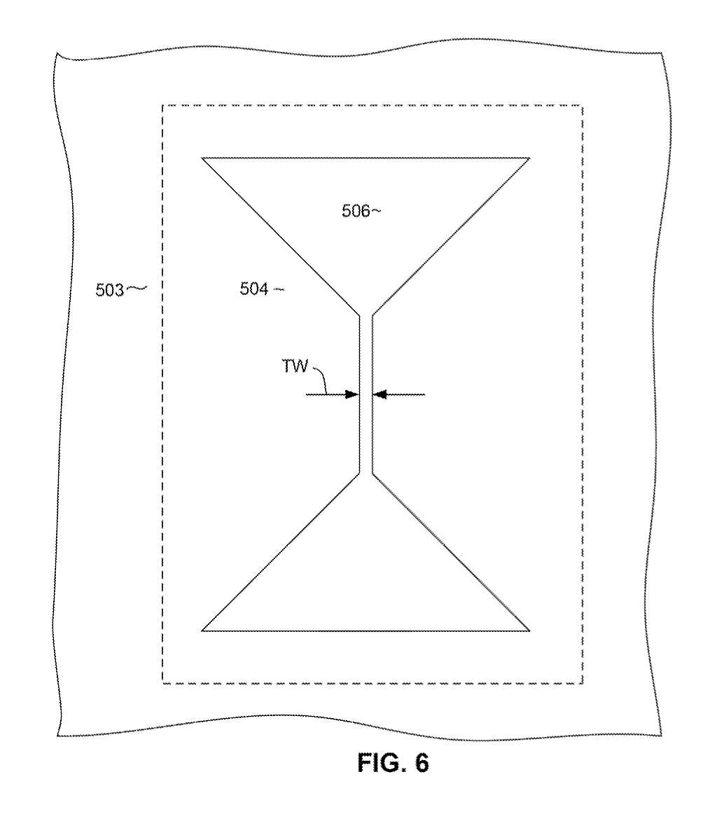

FIGS. 5-19 show a magnetic sensor and lapping guide structure according in various intermediate stages of manufacture, illustrating a method of manufacturing a magnetic sensor according to an embodiment of the invention. With particular reference to FIG. 5, a bottom shield 502 is formed in a sensor area which is surrounded by a coplanar insulation layer such as alumina 503 in areas outside of the sensor area. A plurality of layers of sensor material shown collectively as a sensor layer 504 is deposited full film over the shield 502 and insulating fill material 503. A mask structure 506 is formed over the sensor material 504. The mask 506 can be a photolithographically patterned photoresist and can include other layers to, such as an antireflective coating, adhesion layer, hard mask, CMP stop, etc. FIG. 6 shows a top down view and shows how the mask 506 is configured to define a sensor track width TW.

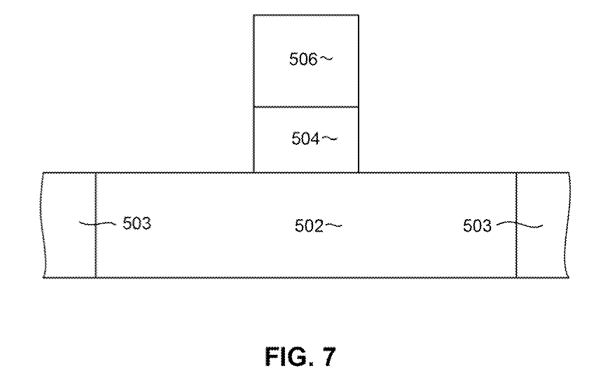

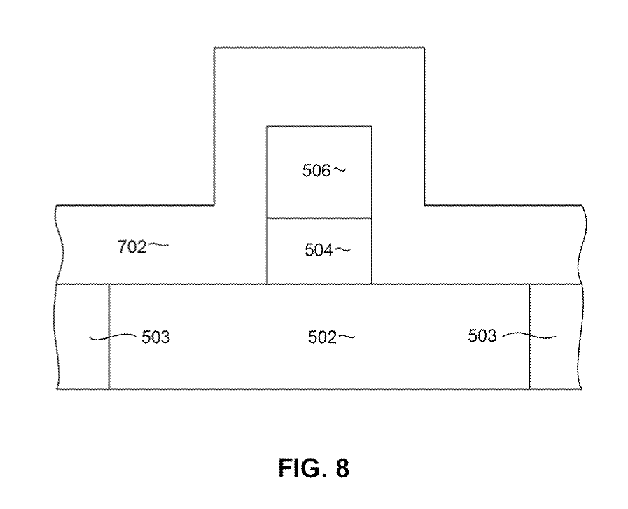

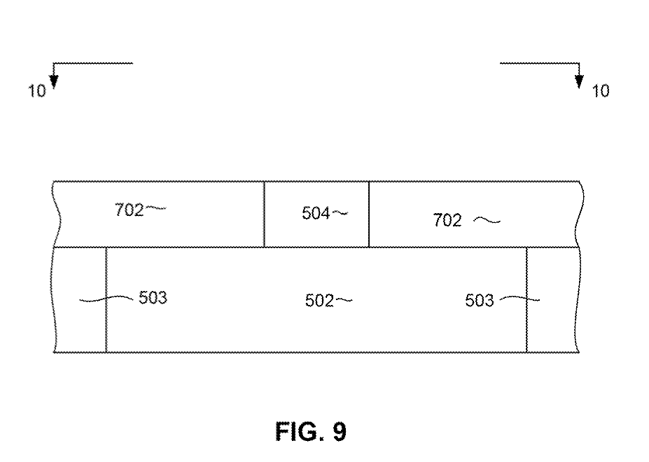

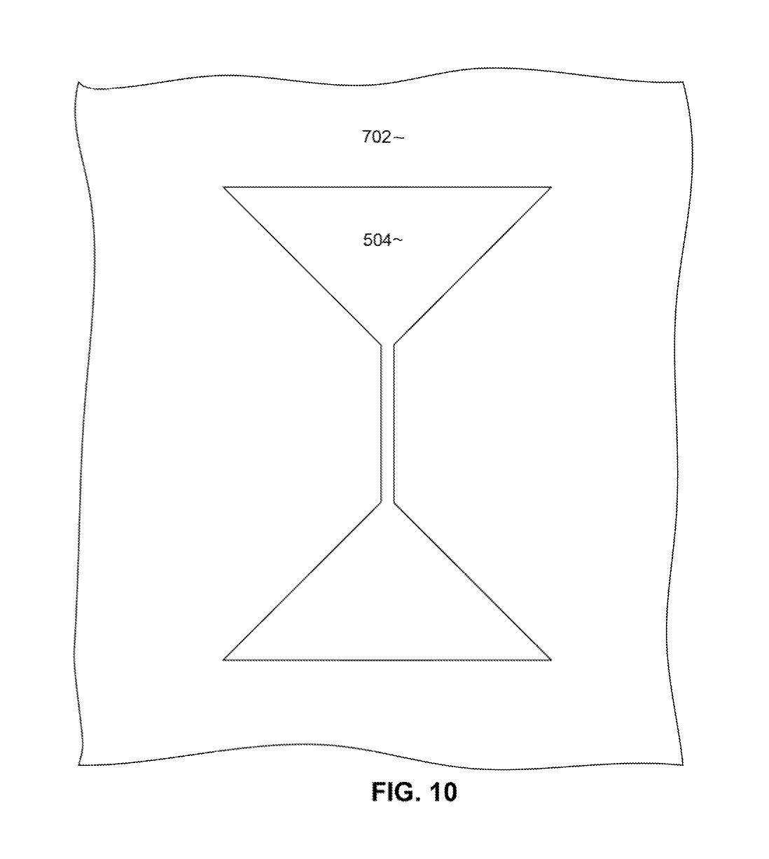

With reference now to FIG. 7, an ion milling is perforated to remove portions of the sensor material 504 that are not protected by the mask structure 506. Then, a non-magnetic, electrically insulating fill material is deposited as shown in FIG. 8. An optional a CMP stop can be deposited. A chemical mechanical polishing process can then be perforated to leave a structure as shown in FIGS. 9 and 10, with FIG. 9 being a cross-sectional view of a plane parallel with the air bearing surface plane and FIG. 10 being a top down view as seen from line 10-10 of FIG. 9.

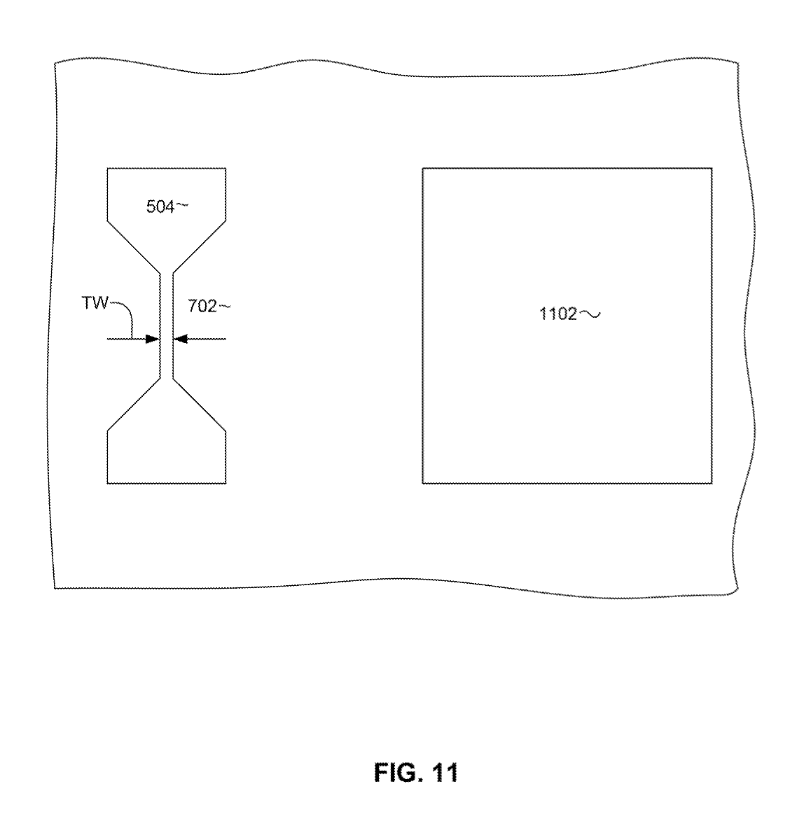

FIG. 11 shows an expanded view showing the sensor material 504 previously patterned to define the track-width as described above. FIG. 11 also shows an adjacent region wherein an electric lapping guide structure (ELG) will be constructed. A layer of ELG material 1102 is deposited in the adjacent ELG region next to the sensor 504. The ELG material can be a material such as Ru/Ta, Rh/Ta, etc and can be formed by a masking, ion milling, and deposition process that can include forming a mask, ion milling out sensor material 504, depositing the ELG material and lifting off the mask to leave the structure 1102 as shown.

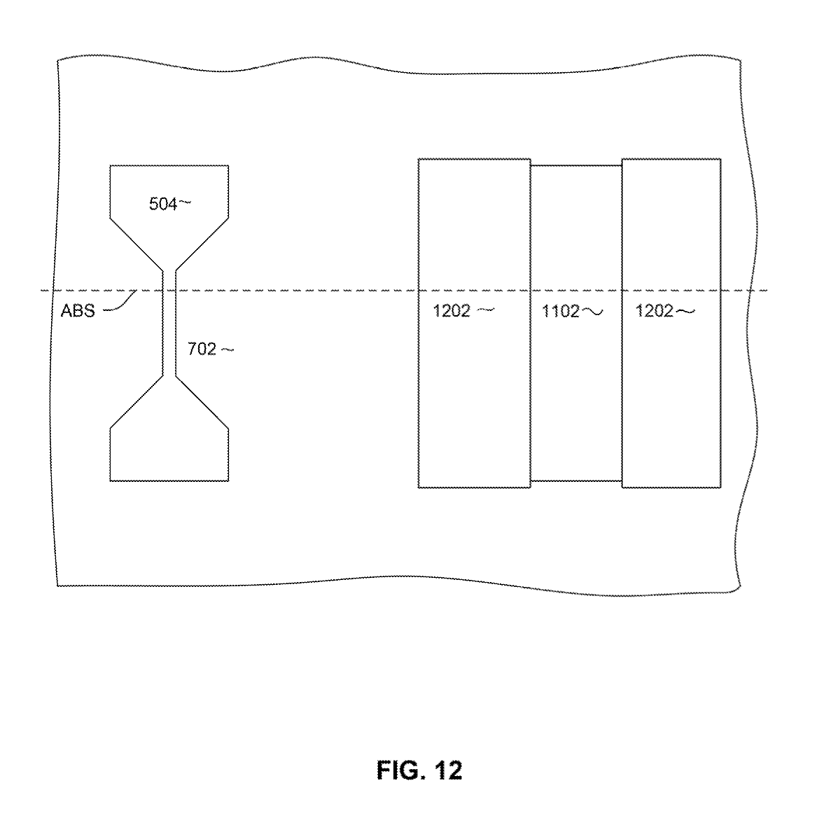

Then, with reference to FIG. 12, first and second laterally opposed lead layers 1202 are formed at first and second sides of the ELG material. The leads 1202 can be constructed of a material having good electrical conductivity such as Cr, and as with the ELG layer, they can be formed by a process that includes forming a mask, ion milling out ELG material, depositing the lead material 1202 and lifting of the mask.

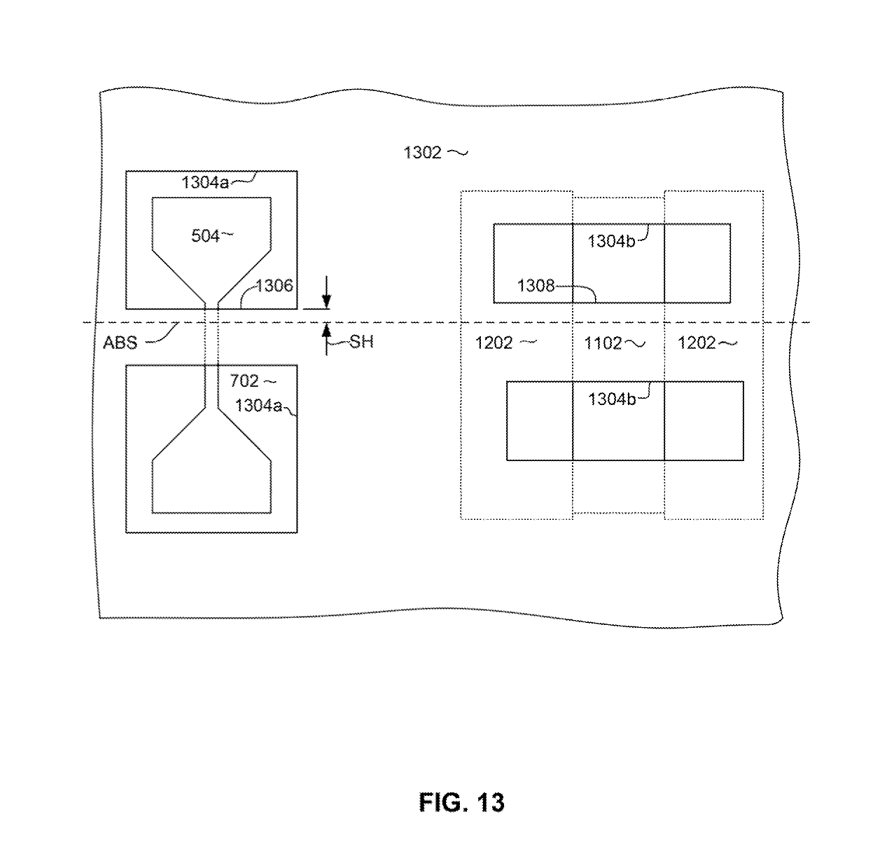

With reference now to FIG. 13, another mask structure 1302 is formed. This mask is configured to determine the stripe height SH of the sensor 504 and also to form a pocket into which a hard bias and thin insulation layer will be deposited, as will be seen below. In FIG. 13, the dashed line denoted ABS indicates the location of an intended air bearing surface plane. The actual air bearing surface will be defined by slicing and lapping processes after the read and write heads have been constructed. The mask 1302 has openings 1304a that are configured to define the stripe height SH of the sensor 504, and also has two openings 1304b in the ELG region that are located on opposite sides of the air bearing surface.

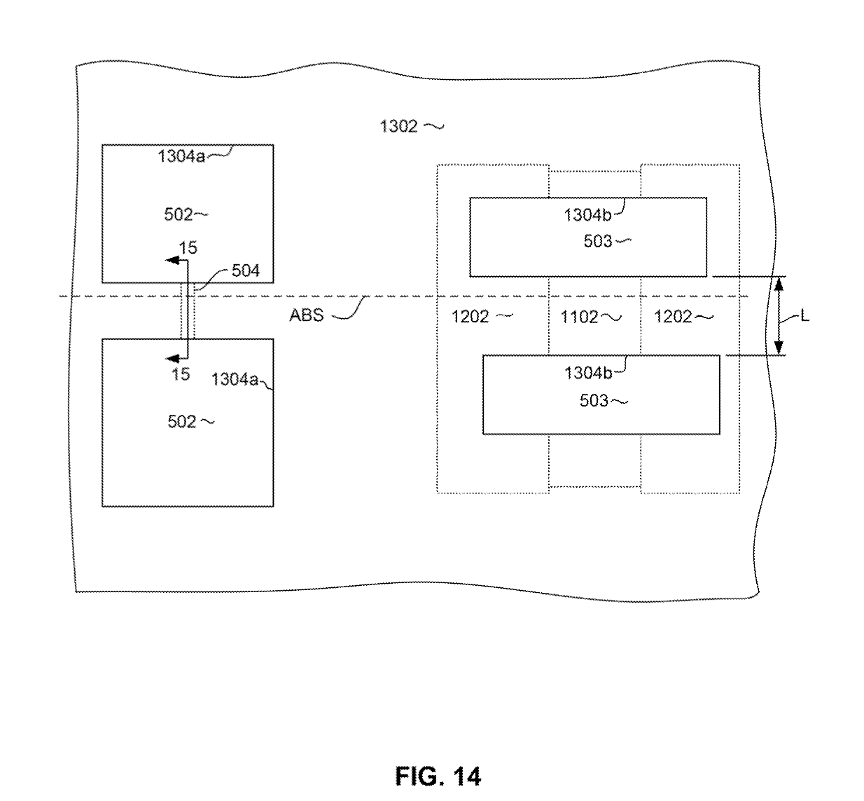

An ion milling can then be performed to remove material not protected by the mask 1302 to expose the under-lying shield 502 in the sensor area and alumina 503 in the ELG area, as shown in FIG. 14. While it can be seen that the configuration of the openings 1304a define the stripe height of the sensor 504, it can also be seen that openings 1304b define the length L of the electrical lapping guide 1102. The length and location of the lapping guide define the electrical resistance of the lapping guide 1102 and determine how this resistance will change during lapping as lapping guide material is removed.

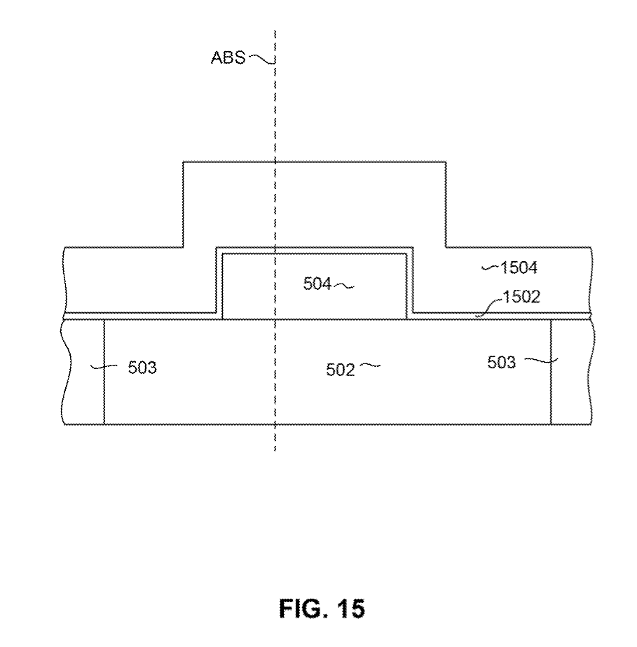

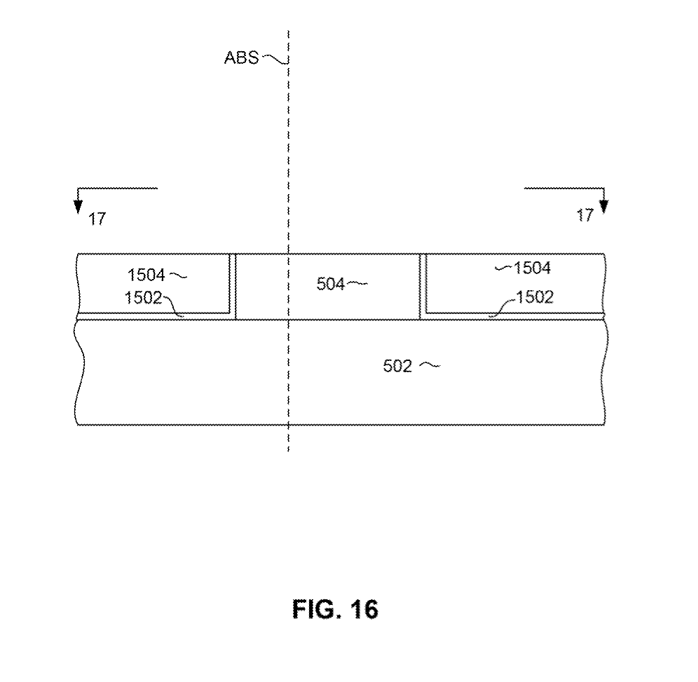

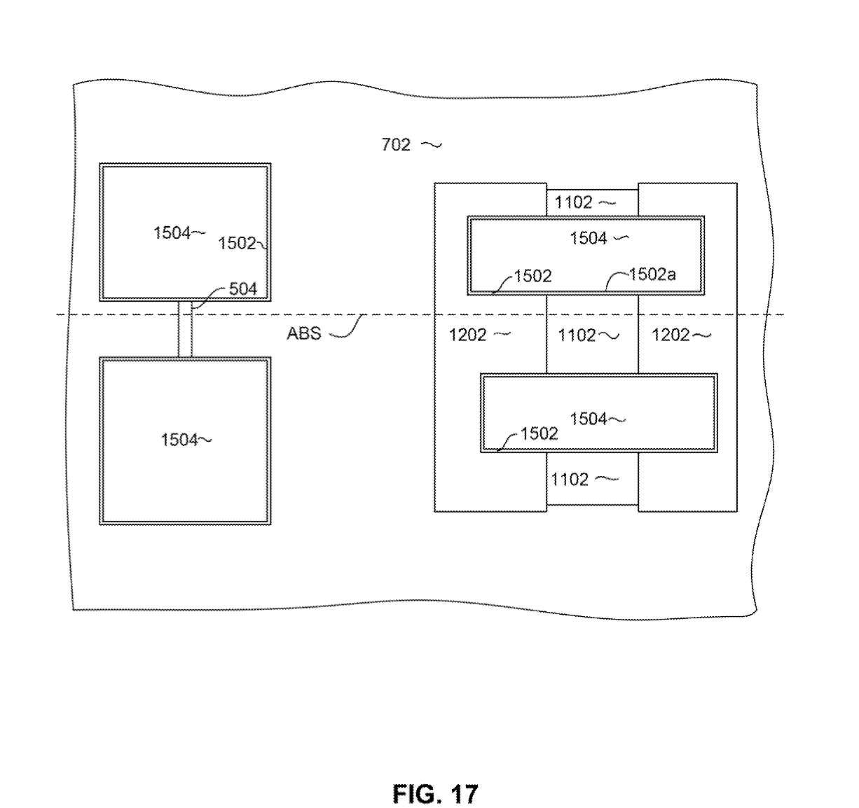

FIG. 15 shows a side cross sectional view as seen from line 15-15 of FIG. 14. With reference to FIG. 15, a thin insulation layer 1502 is deposited followed by a thicker magnetic hard bias layer. The thin insulation layer 1502 can be constructed of a non-magnetic, electrically insulating material such as alumina (Al₂O₃), which may be deposited by chemical vapor deposition or some other conformal deposition technique. The magnetic hard bias layer 1504 can be a magnetic material having a high magnetic coercivity, such as CoP or CoPtCr, and is preferably deposited with its seed and cap combined to be at least to the height of the sensor material 504. After the layers 1502, 1504 have been deposited, a chemical mechanical polishing process (CMP) can be performed, leaving a structure as shown in FIG. 16. FIG. 17 shows a top clown view as seen from line 17-17 of FIG. 16, and shows how the above process form thin wail of insulation 1502 surrounding the hard bias material 1504.

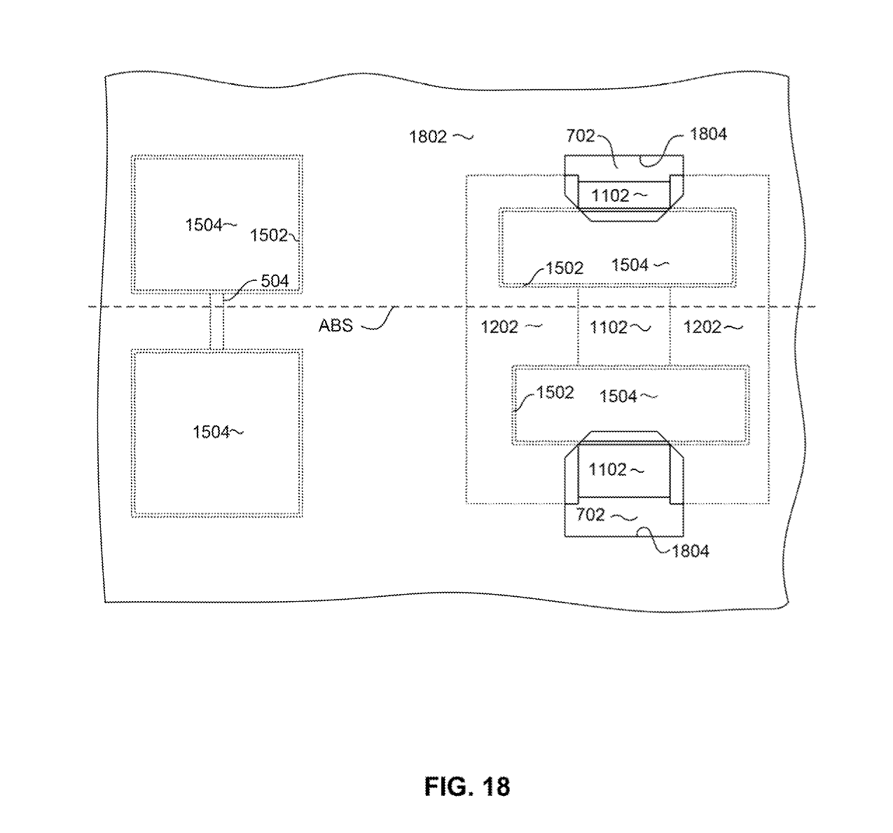

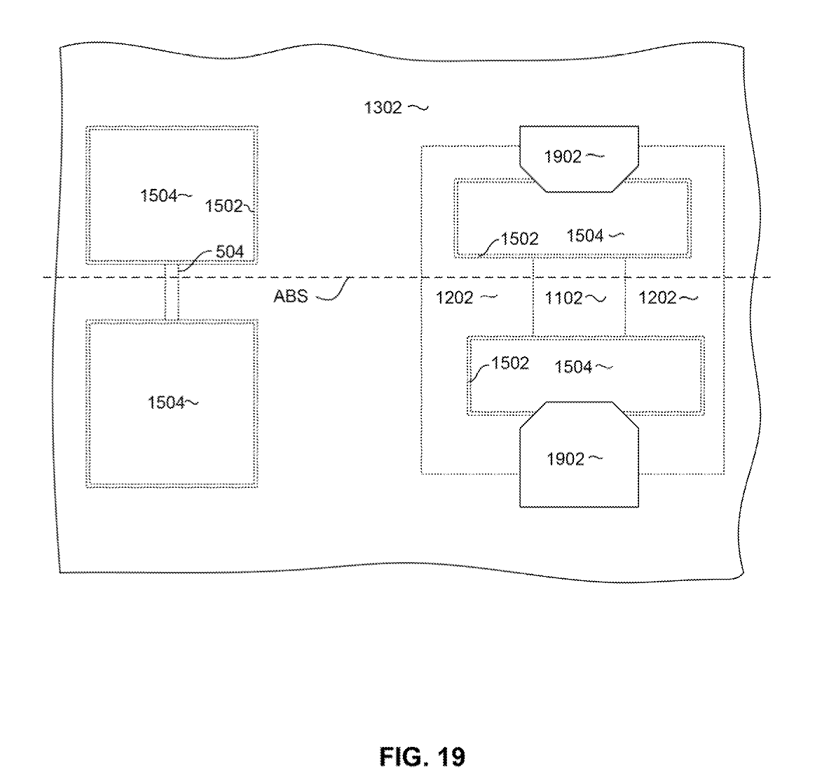

With reference now to FIG. 18, a third mask 1802 can be formed having openings 1804 that are configured to expose unwanted portions of the ELG as shown. Another ion milling can then be performed to remove material that is exposed through these openings 1804 until the underlying alumina 503 (FIG. 14) is reached. Then, an alumina refill 1302 is deposited the mask 1802 is lifted off, leaving a structure as shown in FIG. 19.

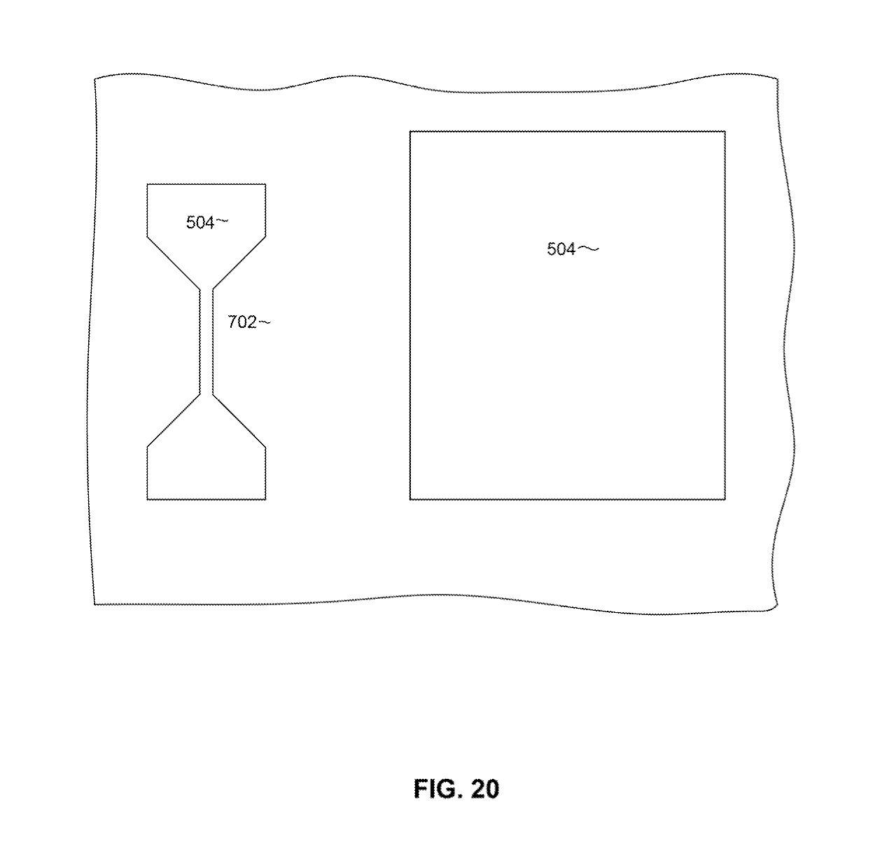

FIGS. 20-27 illustrate a method of manufacturing a magnetic sensor and lapping guide according to another embodiment of the invention.

With particular reference to FIG. 20, a write pole 502 is formed The write pole 20 can be formed by the methods described above with reference to FIGS. 5-10. However, the sensor 504 can be patterned so as to leave sensor material 504 in the ELG region as shown in FIG. 20. The sensor material may also be left remaining in other areas of the wafer as well, although not shown in FIG. 20.

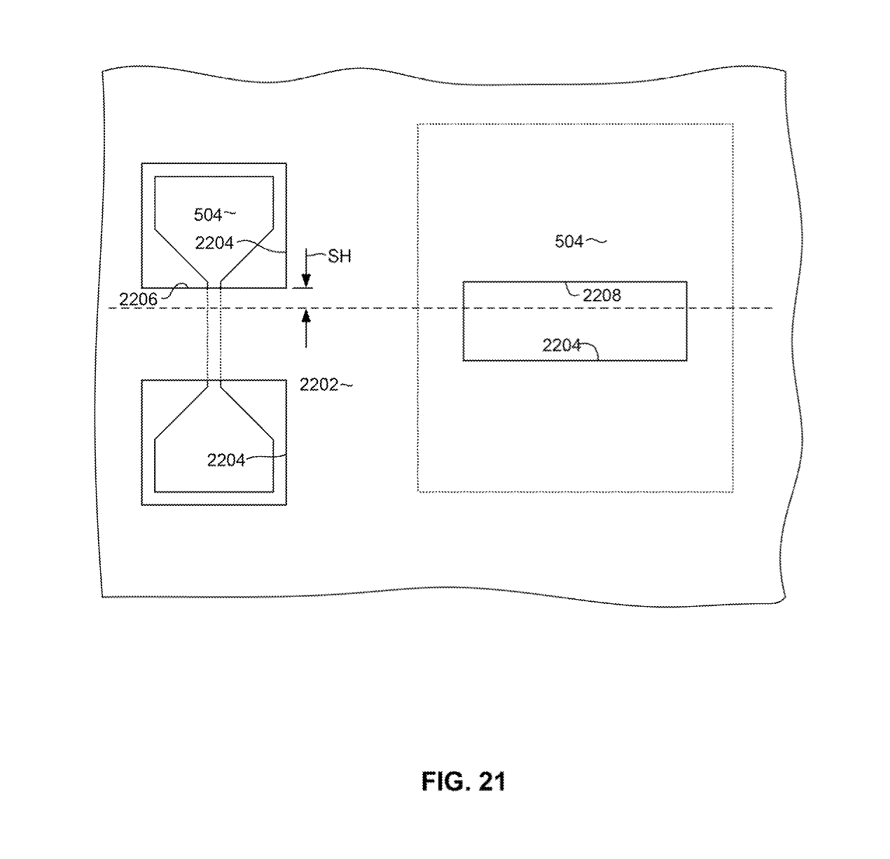

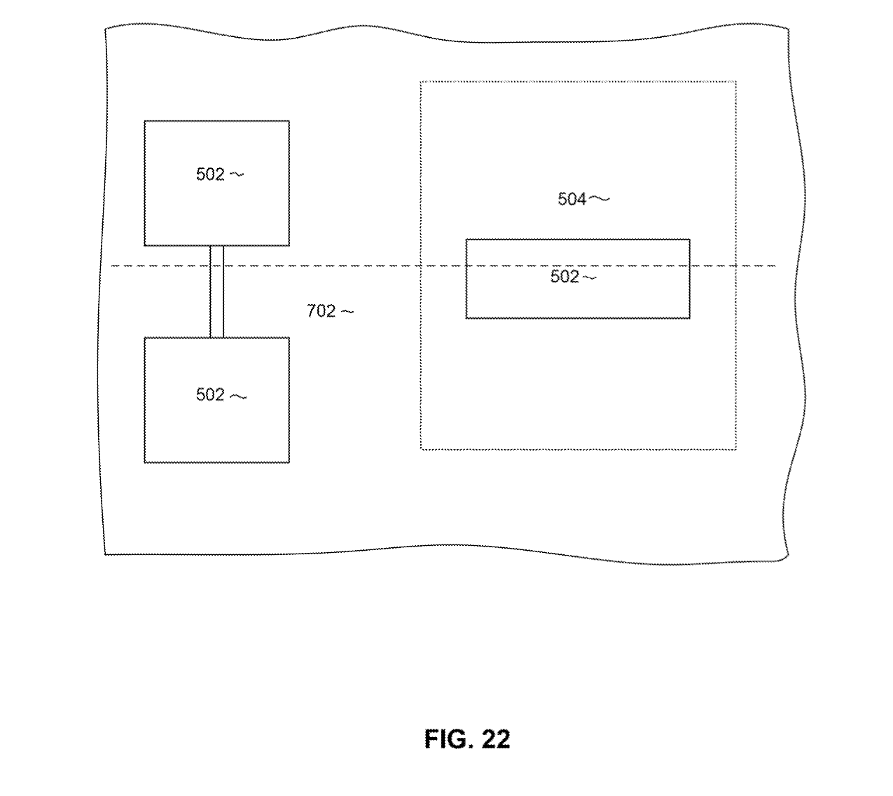

With reference to FIG. 21 a second mask 2202 is formed. The mask 2202 has openings 2204 that are configured to define a sensor stripe height SH in the sensor area and to define an ELG shape in the ELG area. An ion milling is then performed to remove material exposed through the openings 2204 in the mask 2202. The ton milling can be performed until the bottom alumina fill 503 is reached leaving a structure as shown in FIG. 22.

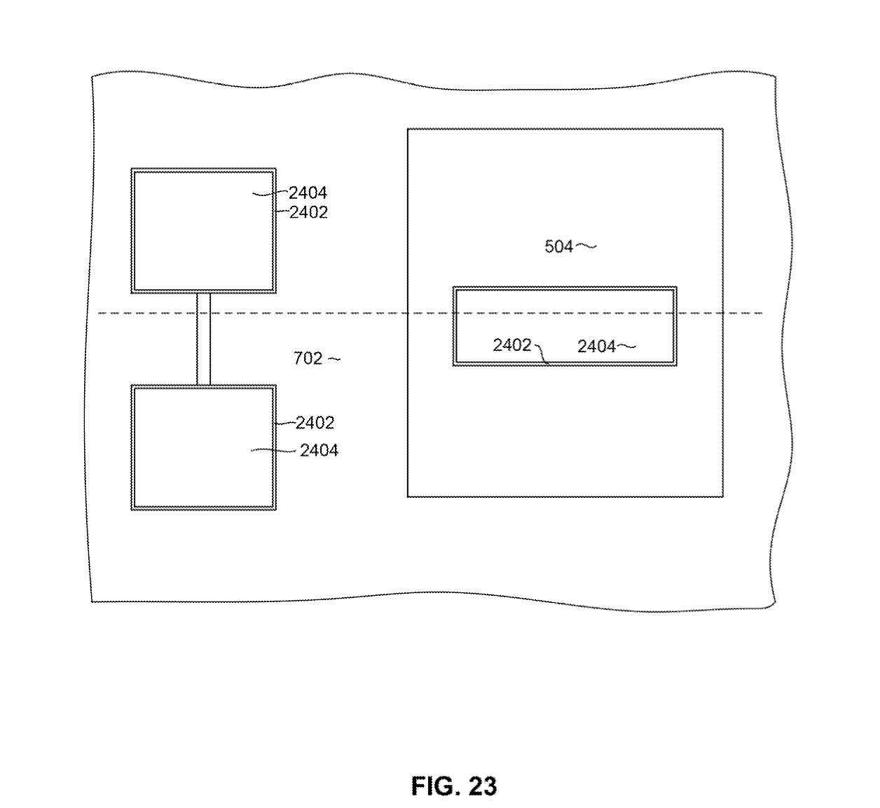

Then, a thin insulation layer 2402 such as alumina, SiN, TaO, or combination thereof is deposited, and a hard magnetic bias material such as CoPt or CoPtCr, followed by a chemical mechanical polishing process. This leaves a structure as shown in FIG. 23 with insulation and hard bias in both the sensor region and the ELG region. In this embodiment, the hard bias material itself can function as the electric lapping guide (ELG).

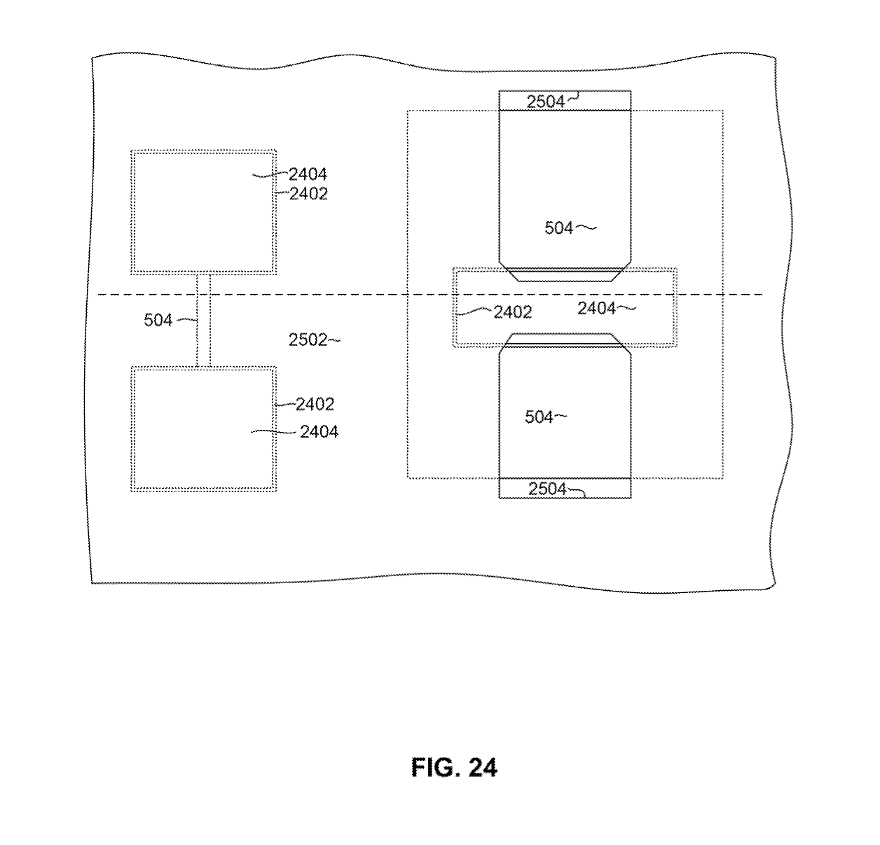

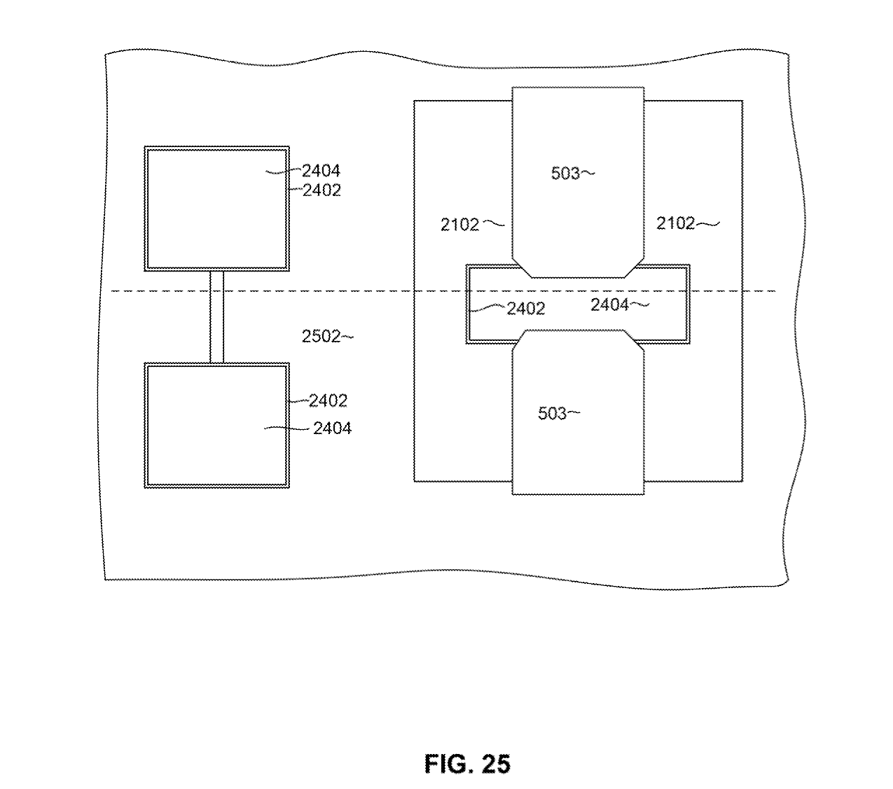

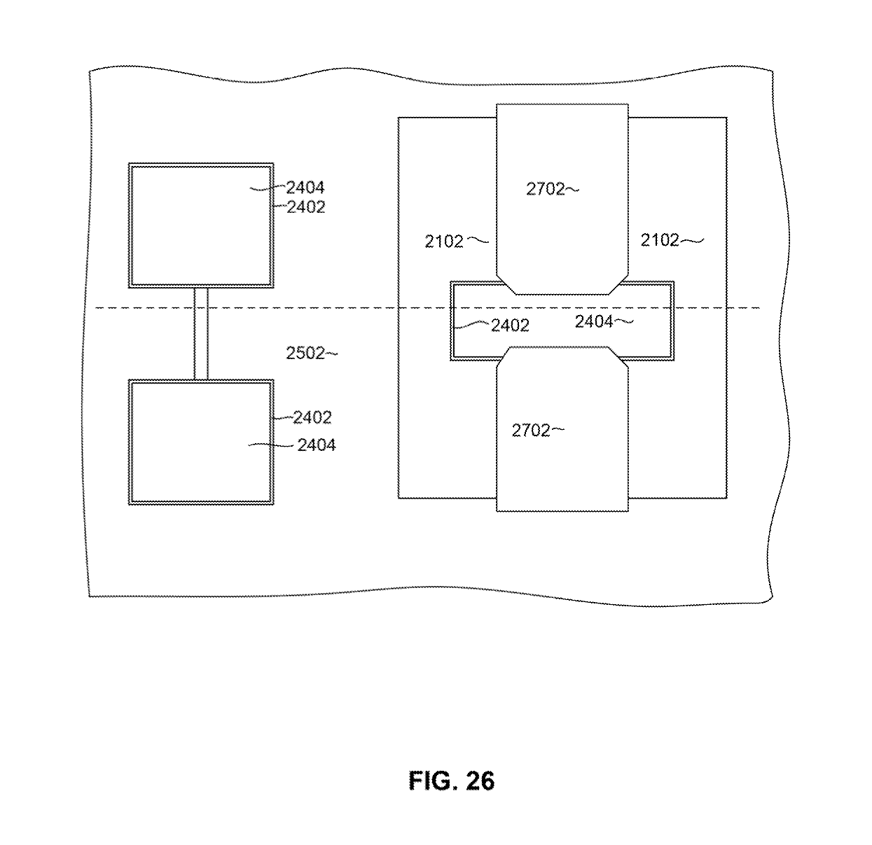

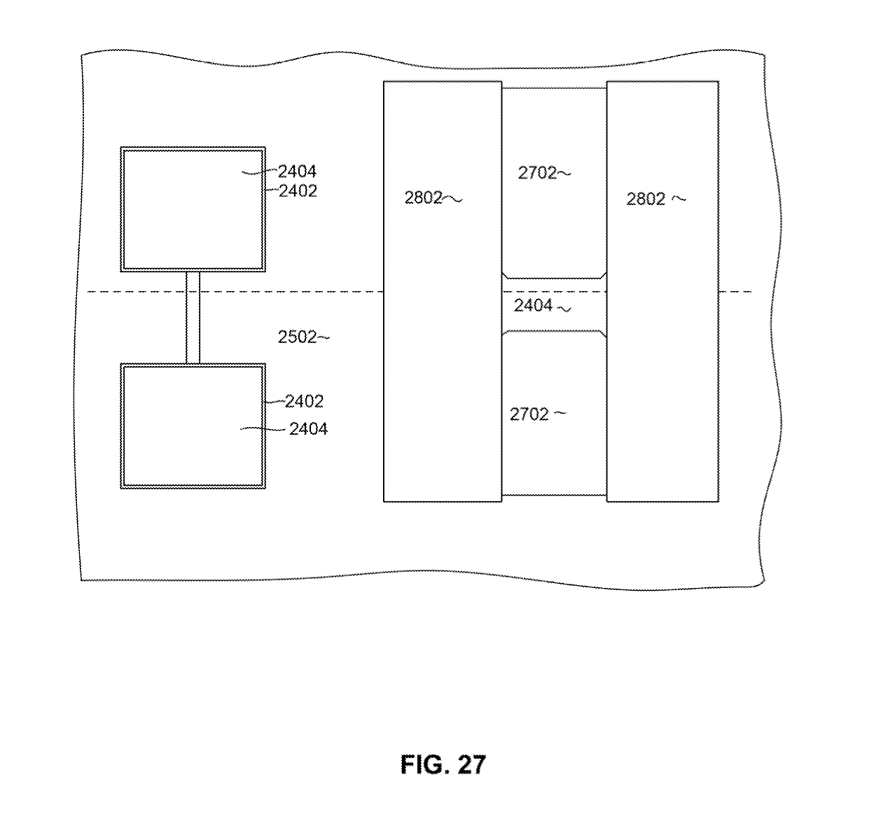

With reference now to FIG. 24 a third mask structure 2502 is formed having openings 2504 formed over the remaining sensor material 504 in the ELG region. An ion milling can then be performed to remove this unwanted sensor material 504, leaving a structure as shown in FIG. 25 with the underlying alumina 503 exposed. Then, an electrically insulating fill material 2702 can be deposited and the mask 2502 can be lifted off, leaving a structure as shown in FIG. 26. Then, with reference to FIG. 27, first and second laterally opposed lead layers 2802 are formed at first and second sides of the ELG material. The leads 2802 can be constructed of a material having good electrical conductivity such as Cr, and as with the ELG layer, they can be formed by a process that includes forming a mask (not shown), ion milling out ELG material, depositing the lead material 2802 and lifting of the mask. Two different methods have been described above, the first being described with reference to FIGS. 5-19, and the second being described with reference to FIGS. 20-27. Both are useful for forming a lapping guide the manufacture of a magnetic sensor having a back edge hard bias structure such as a scissor type sensor. Each of the above described processes has its own advantages and challenges, however.

The first process has the advantage the mask used to define the lapping guide is well aligned with the stripe height of the sensor which allows for accurate definition of the stripe height of the sensor even with photolithographic process variations and deviations. With reference to FIG. 13, it can be seen that the mask used to define the stripe height of the sensor and the and ELG has a back edge 1306 that defines the sensor stripe height SH and has a back edge 1308 that defies the back edge of the lapping guide. It can also be seen that these edges both face in the same direction. This advantageously allows for more accurate alignment of the ELG back edge with the sensor back edge. This is because process variations (such as shadowing or mask misalignment) in the photolithographic process used to define the mask 1302 will have the same effect on both edges 1306, 1308. They will move in the same direction.

However, a challenge arising from use of the first method can be seen with reference to FIG. 17. In FIG. 17 it can be seen that the ELG 1102 is separated from the hard bias material 1504 by the thin insulation layer 1502 at the location 1502a. In this embodiment, the ELG 1102 should be electrically insulated from the hard bias material 1504 or else the hard bias material will function as a part of the ELG during lapping and an accurate determination of ELG resistance would not be attained. However, the insulation layer 1502 is very thin, so as to maximize the hard bias field for biasing the sensor layers. Therefore, any voids or defects in the insulation layer 1502 in the ELG area 1502a would detrimentally affect the lapping accuracy.

On the other hand, the embodiment discussed with reference to FIGS. 20-27 does not have this problem. In this embodiment, the hard bias material itself is used as hard bias material, and in the ELG region, the hard bias is only in the area where the lapping guide is desired. This can be seen with reference to FIG. 27, where it can be seen that the hard bias material 2404 is formed where the lapping guide is desired, and there is no electrically conductive material adjacent to the material 2404, except for the leads 2102. However, with reference to FIG. 22, it can be seen that the mask 2202 used to define the sensor stripe height SH has an edge 2206 that defines the sensor stripe height SH and has an edge 2208 that defines the back edge of the ELG structure. It can also be seen that these edges 2206, 2208 face in opposite directions. Therefore, photolithographic variations such as from shadowing, will may cause these edges 2206, 2208 to move independently of one another. Therefore, accuracy of the relative locations of the hack edge of the sensor and back edge of the lapping guide may suffer. Therefore, the decision of which of the above processes to employ is a matter of design choice and involves a tradeoff between these benefits and challenges.

After forming the sensor 504 and electrical lapping guide (ELG) 2404 (FIG. 27) or 1102 (FIG. 19) by either of the two processes described above, the wafer on which they are formed is sliced into rows. A lapping process is then performed to remove wafer material until the air bearing surface plane ABS is reached. As lapping progresses, a portion of the lapping guide is removed and the resistance across the lapping guide increases. This electrical resistance can be measured across the terminals 1202. When a predetermined resistance is reached (indicating that the ABS plane has been reached) lapping is terminated.

While various embodiments have been described above, it should be understood that they have been presented by way of example only and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A method of manufacturing a magnetic sensor, comprising:
depositing a sensor material;
depositing an electrically conductive material in an electrical lapping guide region;
forming a mask, the mask having an opening with an edge configured to define a hack edge of a sensor and having first and second openings the distance between which is defines an electrical lapping guide;
performing an ion milling to remove material not protected by the mask structure; and
depositing an electrical insulation layer and a magnetic hard bias layer.

2. The method as in claim 1, further composing forming first and second electrically conductive leads that are electrically connected with the lapping guide material.

3. The method as hi claim 1, wherein the electrically conductive material comprises a layer of Ru and a layer of Ta or a layer of Rh and a layer of Ta.

4. The method as in claim 2, wherein the electrically conductive material comprises a layer of Ru and a layer of Ta or a layer of Rh and a layer of Ta, and the first and second electrically conductive leads comprise Cr.

5. The method as in claim 1, wherein the mask has an edge that is configured to define a back edge of the lapping guide and that is parallel to and oriented in the same direction as the edge that is configured to define the back edge of the sensor.

6. The method as in claim 1, further comprising, before forming the mask, performing a masking and ion milling process to define a sensor track width.

7. The method as in claim 1, further comprising, before forming the mask:
performing a masking and ion milling process to define a sensor trackwidth;
depositing a non-magnetic, electrically conductive fill layer; and
performing a chemical mechanical polishing process.

8. The method as in claim 1, wherein the electrically conductive material comprises one or more of Ta, Ru and Rh.

9. The method as in claim 2, wherein the electrically conductive leads comprise one or more of Ta, Ru and Rh, and the electrically conductive leads comprise Cr.

10. The method as in claim 2, further comprising, after depositing the sensor material and before forming the mask, defining forming the sensor material to define a sensor track width.

11. A method for manufacturing a magnetic sensor, comprising:
forming a sensor layer having a track-width;
forming a mask having a first opening with an edge that is configured to define a sensor back edge and having a second opening defining an electrical lapping guide;
performing an ion milling to remove material exposed through the first and second openings;
depositing a layer of electrically insulating material and a layer of hard magnetic bias material over the layer of electrically insulating material; and
performing a chemical mechanical polishing.

12. The method as in claim 11, wherein the hard magnetic bias material in the region of the second opening of the mask defines an electrical lapping guide, the method further comprising forming first and second electrically conductive leads in contact with the electrical lapping guide.

13. The method as in claim 12, wherein the electrically conductive leads comprise Cr.

14. The method as in claim 11, further comprising wherein the deposition of the hard magnetic material forms an electrical lapping guide in the region of the mask structure second opening, the method further comprising:
forming first and second electrically conductive leads electrically connected with the electrical lapping guide;
forming a second mask structure having first and second openings over a region beyond the electrical lapping guide and between the first and second electrically conductive leads; and
performing an ion milling to remove material exposed through the leads.

15. The method as in claim 12 wherein the electrically conductive leads are formed after depositing the layer of electrically insulating material and hard bias material and after performing the chemical mechanical polishing.

16. The method as in claim 11 wherein the second opening has a length in a direction perpendicular to an air bearing surface plane that defines a depth of an electrical lapping guide.

17. The method as in claim 11 wherein the second opening in the mask structure extends across an air bearing surface plane.

18. The method as in claim 17 wherein the second opening in the mask structure has a portion that is located at a first side of the air bearing surface plane and a portion that is located at a second side of the air bearing surface plane.
